(19) United States
(12) Patent Application Publication
(10) Pub. No.: US 2009/0193491 A1
(43) Pub. Date: Jul. 30, 2009

(54) SECURE ELEMENT MANAGER

(76) Inventor: Bindu Rao, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/019,081

(22) Filed: Jan. 24, 2008

(51) Int. Cl. H04L 9/00

(52) U.S. Cl. 726/1

(57) ABSTRACT

In one embodiment, a computing device may comprise system hardware, system firmware, one or more secure elements and one or more secure element management module. The secure element may enable access to goods or services. In some embodiments, the operational status of an embedded secure element may be modified by a secure element management module through addition of hardware, communication with a server or the like.

### BACKGROUND

Modern computing and communication capabilities have created an environment in which user's access resources (e.g., data, applications, goods, services etc.) from different local and remote locations. When users access resources, a secure element may be used to authenticate these computing devices to assure access may be granted to the requested services.

### BRIEF DESCRIPTION OF THE DRAWINGS

FIG. 1 is a schematic illustration of a computing environment in which a secure element in a computing device may be implemented, according to embodiments.

FIG. 2 is a schematic illustration of a computing device adapted to incorporate a secure element, according to embodiments.

FIG. 3 is a flowchart illustrating operations implementing a secure element modification in a computing device, according to embodiments.

FIG. 4 is a flowchart illustrating operations implementing a secure element modification in a computing device, according to embodiments.

FIG. 5 is a flowchart illustrating operations implementing a secure element modification in a computing device, according to embodiments.

### DETAILED DESCRIPTION

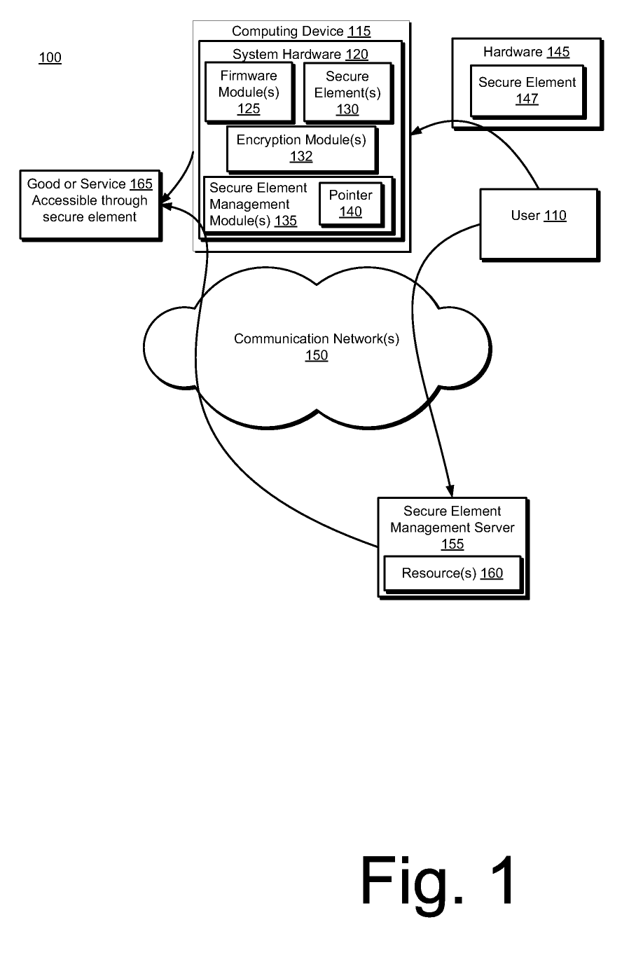

FIG. 1 is a schematic illustration of a computing environment 100 in which a secure element in a computing device 115 may be implemented, according to embodiments. Computing environment 100 is intended to illustrate a client-server network configuration, and may represent a computing environment that spans a corporate or college campus, a city, or an entire geographic region.

Computing environment 100 may comprise a computing device 115. In some embodiment, the computing device 115 may include, but is not limited to, system hardware 120, one or more firmware module(s) 125, one or more secure elements 130, one or more secure element management modules 135, and one or more pointer(s) 140. In some embodiments, a secure element 130 may be present in a computing device in an application specific integrated chip (ASIC), a field programmable gate array (FPGA), system hardware 120, firmware modules 125 or the like, and may be downloaded alone or in combination with an application such as, e.g., a JAVA applet. In some embodiments, secure element management module 135 may be implemented as an open mobile alliance (OMA) client, in which case secure element management server 155 would be implemented as an OMA server.

In some embodiments, a pointer 140 may be used to locate one or more secure element(s) 130. In some embodiments, a pointer 140 may disable an embedded secure element and re-provision a computing device to use a new secure element. In some embodiments, a firmware update may redirect a pointer which in turn may disable an embedded secure element and point to a new secure element. For example, in the embodiment depicted in FIG. 1, the pointer 140 may be updated, e.g., by the secure element management module(s) 135) to point to a secure element 130, or to point to a secure element 147 in hardware 145, or to another device in the event an additional device is introduce into the computing device 115.

In some embodiments, a computing device 115 may include an encryption module 132. In some embodiments, an encryption module 132 may allow a user to modify the operational status of a secure element through receipt of an encrypted modification request from a server or the like.

In some embodiments, the operational status of a secure element in a computing device 115 may be updated or modified by various means, such as but not limited to, the addition of hardware 145, update through use of a secure element management server 155, or the like. By way of example and not limitation, the additional hardware may be in the form of, but not limited to, a secure digital (SD) card, micro-card or the like. In some embodiments, the additional hardware 145 may include an updated or modified secure element 147. By way of example and not limitation, a computing device may update an associated secure element to provide enhanced secure element features that may be used instead of the secure element which may be embedded in a computing device.

A secure element management server may comprise resources 160, such as, e.g., applications, storage, or other resources. In some embodiments, a secure element management server 155 may be coupled to a computing device 115, a user 110 or the like, through a communication network 150. The specific implementation of the communication network is not critical. In some embodiments the communication network 150 may be implemented as, e.g., an IP network. In some embodiments, a secure element management server 155 may receive a secure element modification request from a user 110, and a secure element modification request may be encrypted. By way of example and not limitation, a request may use encryption protocols, such as, but not limited to, RSA encryption, or the like.

In operation, a computing device may be made available for a user 110, with embedded firmware module(s) 125 on the system hardware 120. Furthermore, the firmware module(s) 125 may include a secure element 130 that may allow the user 110 access to goods or services 165. In some embodiments, a secure element 130 may be used to facilitate secure transactions, secure management sessions, or the like. By way of example, and not limitation, a service provider may make available to a user 110 a computing device 115 in which a secure element 130 is pre-installed to interact with a specified merchant.

In operation, additional hardware 145 may be added to the computing device 115 to update or modify the computing device's functionality. In some embodiments, the additional hardware 145 includes a modified secure element 147 that is intended as an update to the embedded secure element 135. In such embodiments, a computing device 115 pointer 140 may deactivate or set aside the embedded secure element 130, and point to the new secure element 147.

In operation, in some embodiments, a secure element management server 155 may be used to modify the operational status of a secured element 130 in a computing device 115 by communicating a modification request through a communication network 150. By way of example, and not limitation, a user 110 may lose his or her computing device 115 and may wish to deactivate any secure elements 130 in the computing device 115 to avoid allowing others improper access to goods or services 165. Alternatively, a user may wish to access a good or service, for example a banking application or a shopping application. A user may make a request to a secure element management server 155 to deactivate or otherwise modify the operating status of the secure element 130. By way of example and not limitation, this request may be performed through accessing a self-care webpage that may allow the user 110 to lock the secure element 130 or disable the secure element 130 until the device has been recovered.

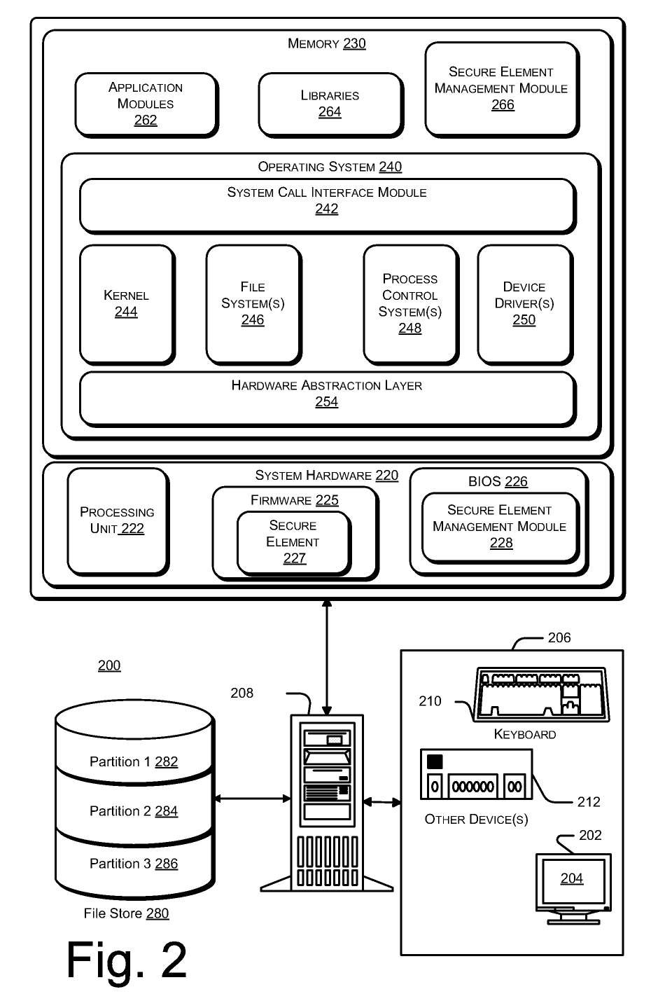

FIG. 2 is a schematic illustration of a computing device adapted to incorporate a secure element, according to embodiments. The computing device 200 includes a computing engine 208 and possibly one or more accompanying input/output devices 206 including, but not limited to, a display 202 having a screen 204, a keyboard 210, and other I/O device(s) 212. The other device(s) 212 may, by way of example, and not by limitation, include a touch screen, a voice-activated input device, a track ball, a mouse and any other device that allows the computing device 200 to receive input from a developer and/or a user.

The computing engine 208 includes system hardware 220 commonly implemented on a motherboard and at least one auxiliary circuit board. System hardware 220 includes a processor 222 and a basic input/output system (BIOS) 226. BIOS 226 may be implemented in flash memory and may comprise logic operations to boot the computer device and a power-on self-test (POST) module for performing system initialization and tests. In operation, when activation of a computing device 200 begins processor 222 accesses BIOS 226 and shadows the instructions of BIOS 226, such as power-on self-test module, into operating memory. Processor 222 then executes power-on self-test operations to implement POST processing.

Computing device 200 further includes a file store 280 communicatively connected to computing engine 208. File store 280 may be internal such as, e.g., one or more hard drives, or external such as, e.g., one or more external hard drives, network attached storage, or a separate storage network. In some embodiments, the file store 280 may include one or more partitions 282, 284, 286.

Memory 230 includes an operating system 240 for managing operations of computing engine 208. In one embodiment, operating system 240 includes a hardware abstraction layer 254 that provides an interface to system hardware 220. In addition, operating system 240 includes a kernel 244, one or more file systems 246 that manage files used in the operation of computing engine 208 and a process control subsystem 248 that manages processes executing on computing engine 208. Operating system 240 further includes one or more device drivers 250 and a system call interface module 242 that provides an interface between the operating system 240 and one or more application modules 262 and/or libraries 264. The various device drivers 250 interface with and generally control the hardware installed in the computing system 200.

In operation, one or more application modules 262 and/or libraries 264 executing on computing engine 208 make calls to the system call interface module 242 to execute one or more commands on the computer's processor. The system call interface module 242 invokes the services of the file systems 246 to manage the files required by the command(s) and the process control subsystem 248 to manage the process required by the command(s). The file system(s) 246 and the process control subsystem(s) 248, in turn, invoke the services of the hardware abstraction layer 254 to interface with the system hardware 220. The operating system kernel 244 can be generally considered as one or more software modules that are responsible for performing many operating system functions.

The particular embodiment of operating system 240 is not critical to the subject matter described herein. Operating system 240 may, for example, be embodied as a UNIX operating system or any derivative thereof (e.g., Linux, Solaris, etc.) or as a Windows® brand operating system or another operating system.

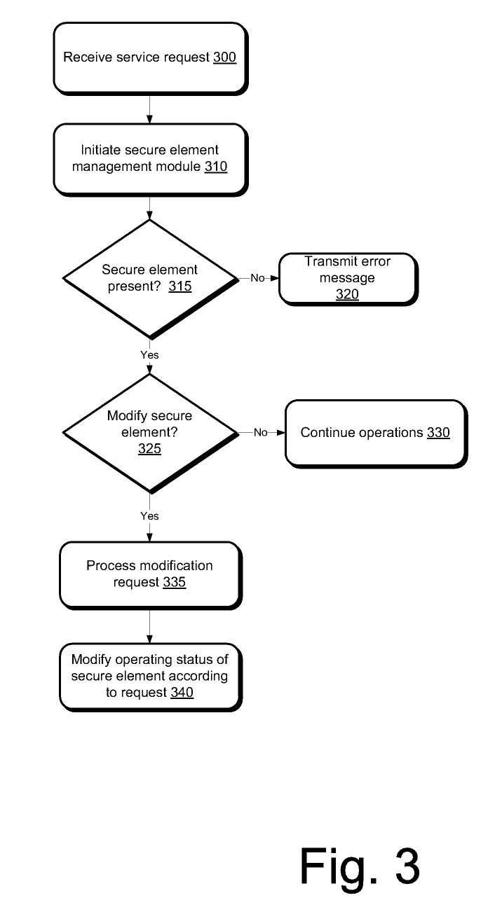

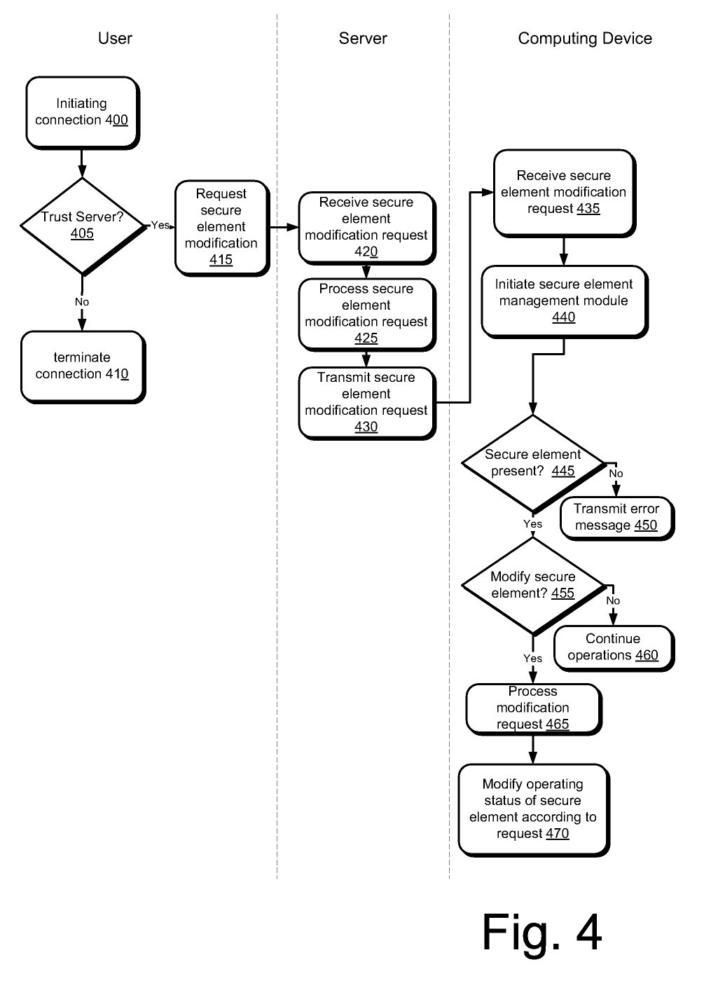

In some embodiments, computing device 200 includes firmware 225. Firmware 225 may be a computer program embedded in the system hardware 220 and may provide instructions for how devices communicate with other computer hardware or remote devices. Firmware 225 may include at least one secure element 227, which may comprise operational logic and may include or invoke hardware that can communicate with at least one remote device. In the embodiment depicted in FIG. 2, BIOS 226 includes a secure element management module 228 and system memory 230 includes a secure element management module 266. In some embodiments, a secure element management module may include a pointer to manage use of multiple secure elements, function as an update manager, allow a user to download new secure elements from a server or the like. Operations implemented by the secure element management modules 228, 266 will be discussed in greater detail below, with reference to FIGS. 3 and 4.

FIG. 3 is a flowchart illustrating operations implementing a secure element modification in a computing device, according to embodiments. Referring to FIG. 3, at operation 300, a computing device receives a service request. In response to this service request, at operation 310 a computing device may initiates a secure element management module. In some embodiments, this may occur during the start up of the computing device. In some embodiments, initiating a secure element management module may start as a result of a user input; such as but not limited to, the addition of hardware to a computing device. If at operation 315, a secure element is not present in the computing device, then an error message is sent at operation 320. By contrast, if at operation 315, a secure element is present in the computing device, then at operation 325 the service request is analyzed to determine if a secure element modification request is present.

If at operation 325, a secure element modification request is present, then the secure element management module processes the modification request at operation 335, and finally modifies the operating status of the secure element according to the request at operation 340. By contrast, if at operation 325, there has not been a secure element modification request, then the computing device will resume normal operation at operation 330. By way of example, and not limitation, a user may introduce additional hardware to a computing device. The added hardware may include software to trigger a pointer in the secure element management module to deactivate and replace the embedded secure element with one included in the new hardware.

FIG. 4 is a flowchart illustrating operations implementing a secure element modification in a computing device, according to embodiments. In some embodiments, a user may modify a secure element by access granted through a server. Referring to FIG. 4, at operation 400 a user may initiate communication with a server. If at operation 405, it is determined that the server may not be trusted, then communication is terminated at operation 410. By contrast, if at operation 415, it is determined that the server is trustworthy then at operation 415 a secure element modification request may be made by a user. By way of example, and not limitation, a user may wish to deactivate the secure element in his or her computing device because the computing device has been lost or stolen.

At operation 420, a server may receive a secure element modification request. At operation 425, a server may process the secure element modification request. At operation 430, a server may then transmit the processed secure element modification request to a computing device. In some embodiments, a server may encrypt the transmitted message. By way of example, and not limitation, an encrypted message may be used to provide additional security against a third party gaining access to a computing device's secure element.

At operation 435, a computing device may receive a secure element modification request. In response to this request, at operation 440 a computing device may initiates a secure element management module. In some embodiments, this may occur during the start up of the computing device. In some embodiments, initiating a secure element management module may start as a result of a user input; such as but not limited to, the addition of hardware to a computing device. If at operation 445, a secure element is not present in the computing device, then an error message is sent at operation 450. By contrast, if at operation 445, a secure element is present in the computing device, then at operation 455 the user request is analyzed to determine if a secure element modification request is present.

If at operation 455, a secure element modification request is present, then the secure element management module processes the modification request at operation 465, and finally modifies the operating status of the secure element according to the request at operation 470. By contrast, if at operation 455, there has not been a secure element modification request, then the computing device will resume normal operations at operation 460.

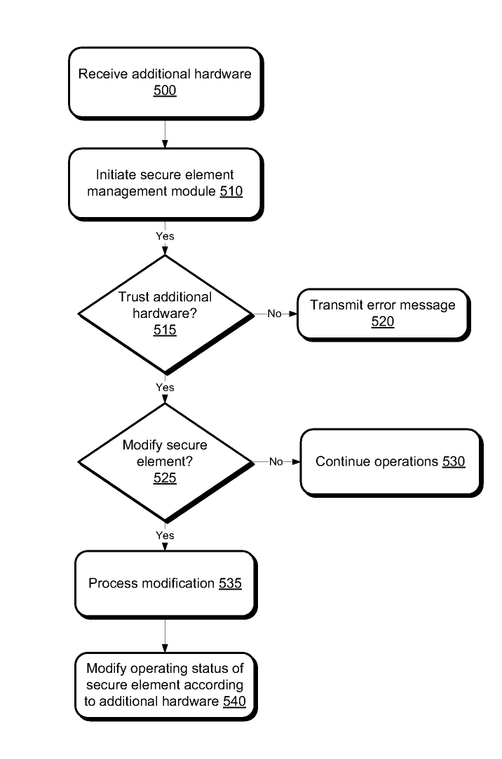

FIG. 5 is a flowchart illustrating operations implementing a secure element modification in a computing device, according to embodiments. A user may modify a secure element in a computing device in a number of ways. By way of example, and not in limitation, a user may introduce new hardware which may contain an updated secure element. Referring to FIG. 5, at operation 500, a computing device may receive additional hardware. In response to the additional hardware, at operation 510 a computing device may initiates a secure element management module. If at operation 515, the additional hardware is not found to be trustworthy, than an error message is transmitted at operation 520. By contrast, if at operation 515, the additional hardware is found to be trustworthy, than at operation 525 the additional hardware is analyzed to determine if it contains a secure element and/or modifications to an embedded secure element. If at operation 525, the additional hardware does not contain a secure element and/or modifications to an embedded secure element, then the computing device may continue operations without modification at operation 530. By contrast, if at operation 525, the additional hardware does contain a secure element and/or modifications to an embedded secure element, then the secure element management module processes any modifications associated with the additional hardware at operation 535, and finally modifies the operating status of an embedded secure element according to the directions from additional hardware at operation 540.

What is claimed is:

1. A computing device comprising:
a system hardware;
at least one firmware module;
at least one secure element; and
at least one secure element management module, wherein the secure element management module comprises a pointer to a currently active secure element.

2. The computing device of claim 1, wherein the at least one secure element management module is coupled to one or more firmware modules.

3. The computing device of claim 1, wherein the at least one secure element management module comprises a pointer to modify the operating status of the secure element.

4. The computing device of claim 3, wherein the pointer in the at least one secure element management module is initiated through introduction of hardware.

5. The computing device of claim 3, further comprising an encryption module.

6. The computing device of claim 5, wherein the secure element management module pointer is initiated through receipt of encrypted request from a server.

7. A method, comprising:
receiving, in a computing device, a service request by a user to modify an operating status of a secure element associated with the computing device;
initiating, in a computing device, a secure element management module; and
in response to the secure element management module, modifying, in a computing device, the operating status of a secure element in response to the service request.

8. The method of claim 7, wherein the secure element management module:
processes the modification request; and
modifies the operating status of the secure element by changing a pointer in the computing device firmware.

9. The method of claim 8, wherein changing a pointer in the computing device firmware comprises:
disabling a secure element; and
providing reference to a different secure element.

10. The method of claim 7, wherein the service request by a user comprises:
initiating, by a user, a communication connection with a server;
verifying that the server is trusted; and
requesting a secure element modification from the server.

11. The method of claim 10, further comprising:
receiving, in a server, the secure element modification request;
processing, in a server, a secure element modification request; and
transmitting, a secure element modification request to the computing device.

12. A method, comprising:
receiving, in a computing device, a secure element provided in additional hardware;
initiating, in a computing device, a secure element management module; and
in response to the secure element management module, modifying, in a computing device, the operating status of an embedded secure element.

13. The method of claim 12, wherein the secure element management module:
detects a secure element provided in additional hardware;
verifies the additional hardware is trusted; and
modifies the operating status of the secure element by changing a pointer in the computing device firmware.

14. The method of claim 13, wherein changing a pointer in the computing device firmware comprises:
disabling the embedded secure element; and
providing reference to the secure element in the memory card.
